(19) United States
(12) Patent Application Publication
(10) Pub. No.: US 2018/0240167 A1
(43) Pub. Date: Aug. 23, 2018

(54) ELECTRONIC SYSTEM AND METHOD FOR FACILITATING PRODUCT PURCHASE

(71) Applicant: MASTERCARD INTERNATIONAL INCORPORATED, Purchase, NY (US)

(72) Inventors: Gaurav Kumar, Sardar Nagar (IN); Kenneth Mark Simpson, London (GB); Sandeep Parvathareddy, Krishna Nagar Guntur (IN); Surbhi Chetwani, Delhi (IN); Aditya Koduri, New Delhi (IN); Ajay Bahadur Singh Panwar, Noida (IN); Gautam Chopra, New Delhi (IN)

(21) Appl. No.: 15/893,103

(22) Filed: Feb. 9, 2018

(30) Foreign Application Priority Data
Feb. 17, 2017 (SG) 10201701301P

(51) Int. Cl. G06Q 30/06

(52) U.S. Cl. CPC G06Q 30/0605; G06Q 30/0635

(57) ABSTRACT

The present disclosure provides an electronic system, a method, and a non-transitory computer medium for facilitating product purchase. The system includes a server including a processor and a memory configured to store computer-readable instructions on the non-transitory computer medium. When the instructions are executed, the processor performs steps of the method, including receiving, from an electronic device of a user, a user selection of products for purchase thereof, identifying, from a merchant database, a plurality of merchants to provide the selected products, collecting prices for the selected products from the merchants, calculating a score for each merchant based on a set of parameters including the collected prices, ranking a number of the merchants according to their scores, receiving, from the electronic device, a user selection of one or more merchants from the ranked merchants, and transmitting purchase instructions for the selected products from the selected merchants at the respective prices.

### CROSS REFERENCE TO RELATED APPLICATIONS

This patent application claims priority to Singapore Application No. 10201701301P filed on Feb. 17, 2017, the disclosure of which is incorporated by reference herein in its entirety as part of the present application.

### BACKGROUND

The present disclosure generally relates to an electronic system and method for facilitating product purchase. More particularly, the present disclosure describes various embodiments of an electronic system and method for facilitating purchase of a user-selection of products from one or more merchants.

Products such as daily goods or necessities, e.g. groceries, toiletries, sundries, are frequently purchased by users or consumers as these products need to be replaced or replenished periodically. Conventionally, users have to commute out of their homes to merchants, whether nearby or elsewhere, to purchase these products. With the advent of electronic commerce or e-commerce, some users switch to online platforms for purchasing these products. Merchants that are part of such online platforms will deliver the purchased products to the users' homes.

One problem with e-commerce is that small merchants without an online presence or an online platform for users to make purchases may find difficulty in managing their business. As more users are switching or migrating to online platforms for product purchase, small merchants stand to lose their market share to the bigger merchants. Even if the small merchants offer better prices for the products, they may not be able to reach out to the users who prefer merchants with an online presence. Users end up paying more for the same products purchased from such online merchants. Further, users need to wait for some time before the purchased products are delivered to their homes.

Thus, for users who rely mainly on online merchants for purchase of products, they will not be aware of offers or promotions by the small merchants, particularly the local merchants that are in the vicinity of the users' homes. Without having sufficient information from most, if not all, of the merchants, the users cannot make informed decisions on their product purchases.

U.S. Pat. No. 8,533,097 discloses a transaction arbiter system that receives price bids from at least one merchant in response to a request-for-quote for a given product or service that a consumer intends to purchase. The system integrates competition among merchant bidders to achieve an optimal consumer price for the given product or service. However, it appears that the system does not take into consideration merchant-related or consumer-input factors other than the price bids; only the optimal (most likely cheapest) price bid is provided to the consumer and the consumer has no influence on which merchant to purchase from.

Therefore, in order to address or alleviate at least one of the aforementioned problems and/or disadvantages, there is a need to provide an electronic system and method for facilitating product purchase, in which there is at least one improved feature over the aforementioned prior art.

### BRIEF DESCRIPTION

A first aspect of the present disclosure provides an electronic system, a method, and a non-transitory computer medium for facilitating product purchase. The system includes a server including a processor and a memory configured to store computer-readable instructions on the non-transitory computer medium. When the instructions are executed, the processor performs steps of the method, including receiving, from an electronic device of a user, a user selection of products for purchase thereof, identifying, from a merchant database, a plurality of merchants to provide the selected products, collecting prices for the selected products from the merchants, calculating a score for each merchant based on a set of parameters including the collected prices, ranking a number of the merchants according to their scores, receiving, from the electronic device, a user selection of one or more merchants from the ranked merchants, and transmitting purchase instructions for the selected products from the selected merchants at the respective prices.

A second aspect of the present disclosure provides an electronic system, a method, and a non-transitory computer medium for facilitating product purchase. The system includes a server including a processor and a memory configured to store computer-readable instructions on the non-transitory computer medium. When the instructions are executed, the processor performs steps of the method, including receiving, from an electronic device of a user, a user selection of products for purchase thereof, identifying, from a merchant database, a plurality of merchants to provide the selected products; collecting prices for the product from the merchants, calculating a score for each merchant based on a set of parameters, automatically performing a merchant selection process for selecting one or more merchants based on at least one of their prices and scores, and transmitting purchase instructions for the selected products from the selected merchants at the respective prices.

An electronic system and method for facilitating product purchase according to the present disclosure is thus disclosed herein. Various features, aspects, and advantages of the present disclosure will become more apparent from the following detailed description of the embodiments of the present disclosure, by way of non-limiting examples only, along with the accompanying drawings.

### BRIEF DESCRIPTION OF THE DRAWINGS

FIG. 1A is an illustration of an electronic system for facilitating product purchase, in accordance with an embodiment of the present disclosure.

FIG. 1B is an illustration of modules/components of a server of the electronic system of FIG. 1A, in accordance with an embodiment of the present disclosure.

FIG. 2A is a flowchart illustration of a computerized method for facilitating product purchase, in accordance with an embodiment of the present disclosure.

FIG. 2B is a flowchart illustration of a computerized method for facilitating product purchase with a merchant selection process, in accordance with an embodiment of the present disclosure.

FIG. 3 is a flowchart illustration of the merchant selection process of FIG. 2B, in accordance with an embodiment of the present disclosure.

FIG. 4A is an illustration of lists of ranked merchants from the merchant selection process, in accordance with another embodiment of the present disclosure.

FIG. 4B is another illustration of lists of ranked merchants from the merchant selection process, in accordance with another embodiment of the present disclosure.

FIG. 5 is a block diagram illustration of the technical architecture of a server of FIG. 1B, in accordance with an embodiment of the present disclosure.

### DETAILED DESCRIPTION

In the present disclosure, depiction of a given element or consideration or use of a particular element number in a particular figure or a reference thereto in corresponding descriptive material can encompass the same, an equivalent, or an analogous element or element number identified in another figure or descriptive material associated therewith. The use of “/” in a figure or associated text is understood to mean “and/or” unless otherwise indicated. As used herein, each of the terms “group” and “set” corresponds to or is defined as a non-empty finite organization of elements that mathematically exhibits a cardinality of at least one (e.g. a set as defined herein can correspond to a unit, singlet, or single element set, or a multiple element set), in accordance with known mathematical definitions. The recitation of a particular numerical value or value range herein is understood to include or be a recitation of an approximate numerical value or value range.

For purposes of brevity and clarity, descriptions of embodiments of the present disclosure are directed to an electronic system and method for facilitating product purchase, in accordance with the drawings. While aspects of the present disclosure will be described in conjunction with the embodiments provided herein, it will be understood that they are not intended to limit the present disclosure to these embodiments. On the contrary, the present disclosure is intended to cover alternatives, modifications and equivalents to the embodiments described herein, which are included within the scope of the present disclosure as defined by the appended claims. Furthermore, in the following detailed description, specific details are set forth in order to provide a thorough understanding of the present disclosure. However, it will be recognized by an individual having ordinary skill in the art, i.e. a skilled person, that the present disclosure may be practiced without specific details, and/or with multiple details arising from combinations of aspects of particular embodiments. In a number of instances, known systems, methods, procedures, and components have not been described in detail so as to not unnecessarily obscure aspects of the embodiments of the present disclosure.

### Overview

The present disclosure relates to an electronic system and computerized method for facilitating product purchase. Products are selected by a user or consumer for purchase from merchants, and the selection of the products can be performed via an electronic device of the user. The method then collects prices of products from multiple merchants, wherein some merchants are located within a vicinity of an address of the user, and calculates a score for each merchant. This enables the system to obtain prices from a variety of merchants, some being big market players while others being smaller merchants near the user, so that the user has the option to select his/her preferred merchant(s) to purchase the selected products. The score calculation is based on multiple parameters including the merchant prices. Based on the scores, a number of the merchants are ranked and can be selected, e.g. based on the ranking position, for purchase of the products.

Some of the parameters for scoring the merchants may relate to prior purchase history of the user, e.g. frequency and recency of prior purchase. The scoring of the merchants may also take into account user feedback of and user affinity to the merchants, as well as performance of the merchants, e.g. delivery promptness. The performance of the merchants may also be based on historical transaction data, such as transaction spend, transaction volume, available offers/discounts, etc. The user may indicate a preferred price range for one or more of the selected products, so that only merchants which are able to meet that price range are selectable. The user may also indicate a preference indication for certain preferred merchants, e.g. a price premium over a benchmark price that the user is willing to pay if the product is purchased from these preferred merchants.

The selection of the merchants may be done manually by the user, or by the system to automatically select merchants for the user. In the latter, the system performs a merchant selection process based on the prices and/or scores. Specifically, the merchant selection process finds a common merchant that is highest ranked in terms of the score and price (lowest price). The merchant selection process thus selects common merchants iteratively for each selected product.

Additionally, the selected products may be allocated into groups, e.g. high-priority products and low-priority products. If there is no one common merchant that is able to provide all the products in one group, additional merchants are subsequently selected. In one example, if the first selected merchant can only provide a subset of the products in one group, e.g. only some of the high-priority products, subsequent merchant(s) are successively selected until the remaining products in the group can be provided. The merchant selection process thus selects common merchants iteratively for each selected product in a group of products before the succeeding group of products.

An advantage of the present disclosure is that each merchant that is selling the products, whether located near the user or elsewhere, has an opportunity to offer a price for the products. Scores will be calculated for all the merchants and they are ranked accordingly. The user can thus know which merchants offer better deals for the products and make an informed decision on which merchant to select for purchasing the products. Particularly, the user is not restricted to only the bigger merchants with an online shopping platform, and can make purchases from nearby local merchants if they offer better deals. The merchants may alternatively be automatically selected for the user via the merchant selection process.

### Description of Embodiments

As used herein, a product refers to an item or article that is marketed or sold by merchants. More broadly, a product is a type of economic commodity that can be bought and sold. Some products include daily goods and necessities such as groceries, toiletries, and sundries that are sold at merchants. A merchant refers to a business operation or facility marketing or selling the products. A merchant, e.g. supermarket, may operate entirely online without a conventional brick-and-mortar store, or may alternatively or additionally have such a store. An electronic device of the user refers to mobile devices, mobile phones, smartphones, personal digital assistants (PDAs), tablets, laptops, and/or computers. The user refers to an individual person or end consumer who is purchasing the products from the merchants.

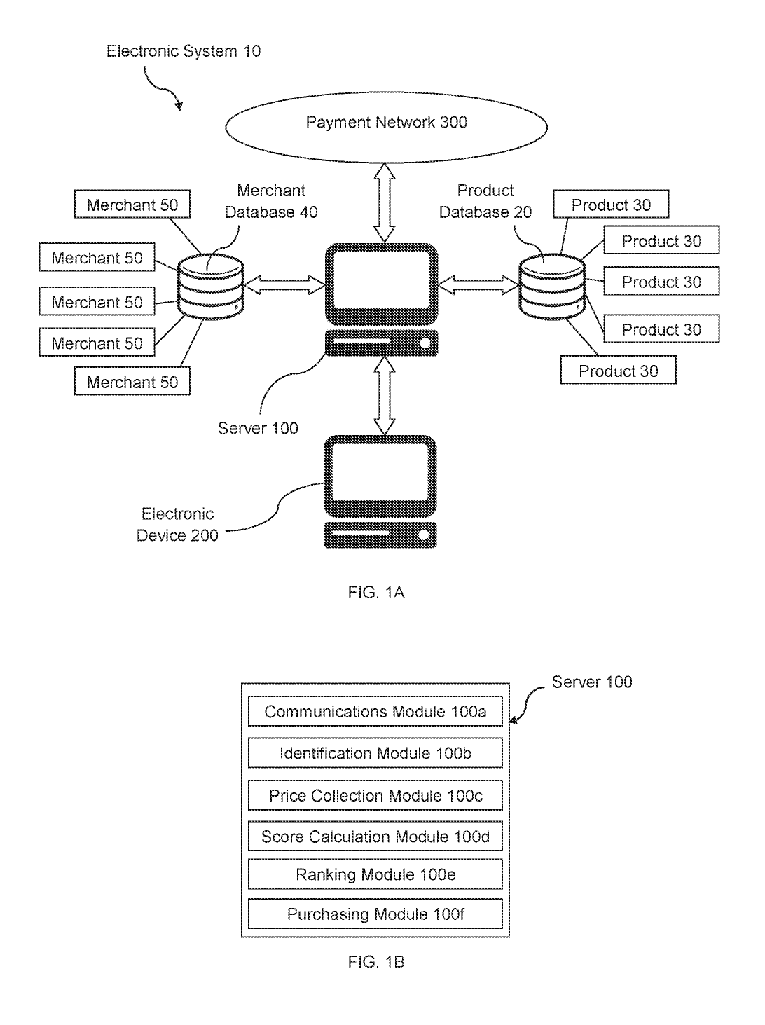

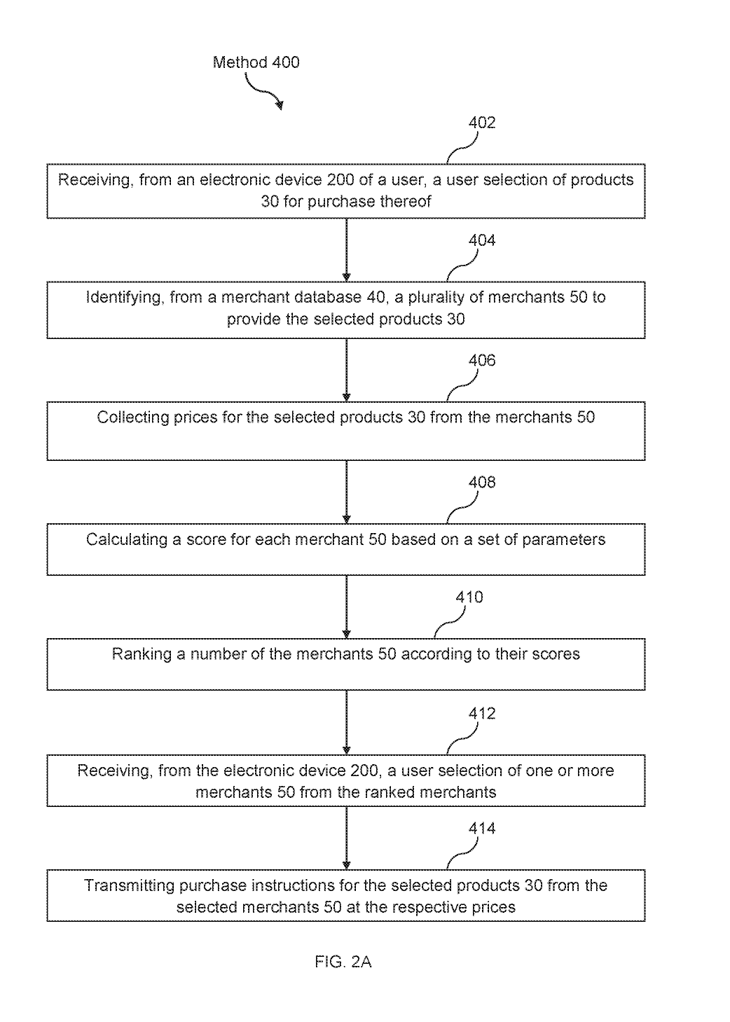

In representative or exemplary embodiments of the present disclosure, there is provided an electronic system 10 as illustrated in FIG. 1A. The system 10 includes a host or server 100 and an electronic device 200 of the user, wherein the server 100 and electronic device 200 are communicatively linked to each other for facilitating product purchase.

The system 10 further includes a product database 20. The product database 20 includes data associated with a range of products 30 offered by merchants. The product data includes, but is not limited to, product identification data such as stock keeping unit (SKU) data, product codes or numbers, manufacturer information, product specifications, etc. The product database 20 may form part of or be connected to the server 100, or the product database 20 may reside on a remote server connected to the server 100.

The system 10 further includes a merchant database 40. The merchant database 40 includes data associated with a range of merchants 50 offering or selling the products 30. The merchant data includes, but is not limited to, merchant identification data, location data, transaction data, products offered by each merchant 50, inventory data, etc. The merchant database 40 may form part of or be connected to the server 100, or the merchant database 40 may reside on a remote server connected to the server 100. Further, the product database 20 and merchant database 40 may be integrated together as a single database or exist as separate independent databases. The merchants 50 are communicatively linked to the server 100 such that they can participate in offering of prices for the products 30. Specifically, computing servers or systems of the merchants 50 are communicatively linked to the server 100. The merchant database 40 may be updated accordingly if there are addition of new merchants 50 or deletion of existing merchants 50 or if there is any change of merchant-related data.

The system 10 further includes a payment network 300 communicatively linked to the server 100. The payment network 300 may be operated by a payment organization or payment card/credit card association, such as MasterCard® or Visa®. Furthermore, the payment network 300 is operated by a computing system that is communicatively linked to the server 100. After the user has made an informed decision on which products 30 to purchase and which merchants 50 to purchase from, payment for the purchase transaction is communicated to the payment network 300 for processing thereof. It will be appreciated that the processing of payment for the purchase transaction is standard and readily known to the skilled person.

In one embodiment, the server 100 is operated by a merchant establishment or commerce organization offering products from a variety of merchants. An example of the merchant establishment or commerce organization is Amazon® which provides a platform connecting a user to multiple merchants. The user may make purchases through the merchant establishment and the server 100 communicates payment instructions to the computing system of the payment network 300. In another embodiment, the server 100 is integrated with the payment network 300 such that the payment organization/payment card association also provides a merchant establishment for the user to make purchases and to directly pay for the purchases.

With reference to FIG. 1B, the server 100 includes a communications module/component 100a, an identification module/component 100b, a price collection module/component 100c, a score calculation module/component 100d, a ranking module/component 100e, and a purchasing module/component 100f.

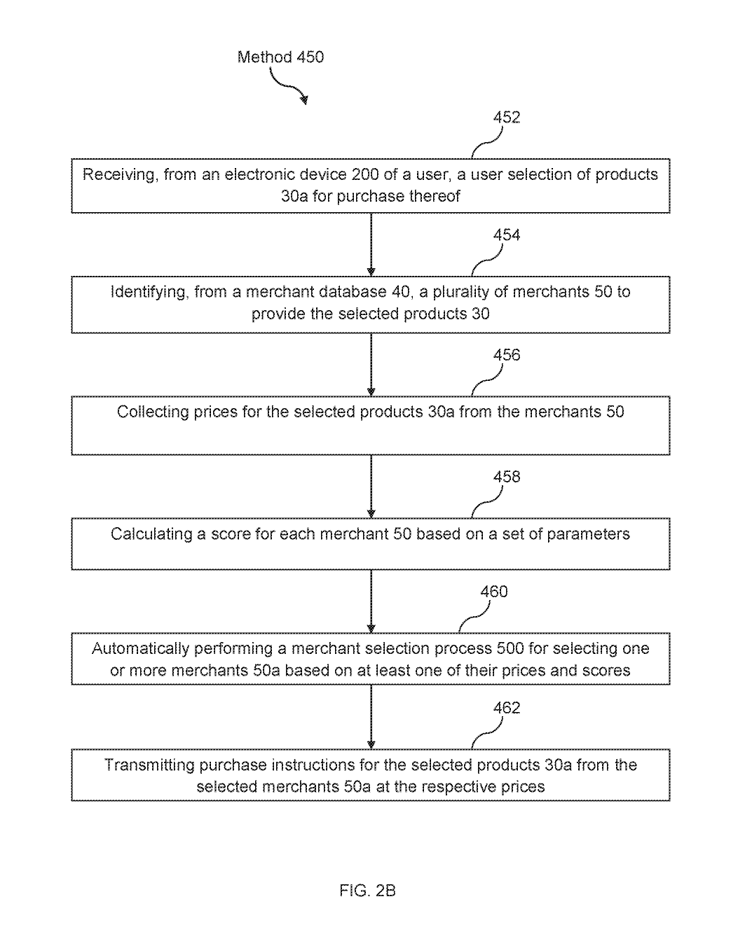

According to the first aspect of the present disclosure and further with reference to FIG. 2A, there is shown a computer-implemented or computerized method 400, i.e. implemented on a computer or computer system such as or including the server 100, for facilitating product purchase. In various embodiments of the present disclosure, the method 400 broadly includes a step 402 of receiving, such as by the communications module or component 100a of the server 100 and from an electronic device 200 of a user, a user selection of products 30 for purchase thereof, a step 404 of identifying, such as by the identification module or component 100b of the server 100 and from a merchant database 40, a plurality of merchants 50 to provide the selected products 30, a step 406 of collecting prices, such as by the price collection module or component 100c of the server 100, for the selected products 30 from the merchants 50, a step 408 of calculating, such as by the score calculation module or component 100d of the server 100, a score for each merchant 50 based on a set of parameters, a step 410 of ranking, such as by the ranking module or component 100e of the server 100, a number of the merchants 50 according to their scores, a step 412 of receiving, such as by the communications module or component 100a and from the electronic device 200, a user selection of one or more merchants 50 from the ranked merchants, and a step 414 of transmitting, such as by the purchasing module or component 100f, purchase instructions for the selected products 30 from the selected merchants 50 at the respective prices.

After the merchants 50 are ranked, one or more merchants 50 are selected (in the step 412) from the ranked merchants 50. Purchase instructions are then transmitted (in the step 414) for purchasing the selected products 30 at the respective prices collected from the one or more selected merchants 50. The merchants 50 are ranked according to predefined algorithms or rules, and the selection of the ranked merchants 50 is performed by the user based on his/her informed decision.

In various embodiments, the user initiates the method 400 for facilitating product purchase with the electronic device 200. Specifically, the user may execute an application, website, plugins, messaging/texting/chatting platforms such as SMS (Short Message Service) or USSD (Unstructured Supplementary Service Data), or any other user interface or input (collectively referred to as “application”) on the electronic device 200 to initiate the method 400. The application presents a range of products 30, including average or default prices thereof, for the user to browse through and determine the appropriate products 30 to purchase. The application running on the electronic device 200 is hosted on a computing or server that may be integrated with or connected to the server 100.

In FIG. 2A, there is shown a computer-implemented or computerized method 400, i.e. implemented on a computer or computer system. Upon selection of the products 30, the electronic device 200 communicates the selection to the server 100 and is received thereby in the step 402. The selection of products refers to the products that the user or consumer has selected for purchase from the relevant merchant(s) 50. For clarity, this selection or products 30 is referred to as selected products 30a. In one embodiment, the selection of products 30 is communicated or embedded with identification data, such that the server 100 is able to identify the selected products 30a from the other products 30. In another embodiment, the server 100 retrieves, by a data retrieval module or component of the server 100 and from the product database 20, product identification data, e.g. SKU data, for the selected products 30a. The product identification data enables the server 100 to identify the selected products 30a from the rest of the products 30 available on the product database 20.

Each of the selected products 30a can be purchased from one or more merchants 50. For each selected product 30a, the step 404 identifies the merchant(s) 50 that are able to provide or sell the selected product 30a. Particularly, the merchant database 40 includes data on the merchants 50 and details of products 30 provided or sold by each merchant 50. Based on identification data of the selected products 30a, the server 100 is able to identify the merchant(s) that can provide each selected product 30a. Collectively, the step 404 identifies the merchants 50 from the merchant database 40 to provide the selected products 30a. For clarity, the identified merchants 50 are referred to as merchants 50a. Some of these identified merchants 50a may include those that are located within a vicinity of an address of the user, such that the selected products 30a can be quickly delivered to the user after purchase. Moreover, nearby merchants 50a may offer a better deal than bigger merchants 50a which may be located farther away.

The step 406 then collects or obtains prices for the selected products 30a from the merchants 50a identified in the step 406. Particularly, for each selected product 30a, the server 100 invites or requests the merchants 50a to offer a price or submit a bid price for the selected product 30a. Some merchants 50a may offer the price for the selected product 30a on real-time basis, i.e. upon request by the server 100. Some merchants 50a may periodically update their prices for the selected product 30a, e.g. daily or weekly, and the updated prices are recorded on the merchant database 40 and retrieved by the server 100. If the server 100 does not receive any offers or bids from one or more of the merchants 50a, the last updated prices by the one or more of the merchants 50a will be taken into consideration. Collectively, the step 406 obtains prices for the selected products 30a from the merchants 50a, such that the prices may be submitted to a pricing algorithm for determining the best deal for the user.

The pricing algorithm is performed in the step 408 by calculating a score for each merchant 50a based on a set of parameters P. One or more of the parameters P may be associated with the prices of the selected products 30a. In the step 408, sub-scores based on each parameter P are calculated, e.g. as a mathematical function of the parameter P. A weight W may be applied to the function. The score for each merchant 50a may calculated by averaging the total sum of the sub-scores. It will be appreciated by the skilled person that the pricing algorithm and the calculation of the scores for each merchant 50a may be modified.

A first parameter P1 relates to prior purchase history of the user with a merchant 50a, e.g. frequency and recency of prior purchase. Frequency refers to the number of times that the user has made prior purchases with the merchant 50a, and recency refers to the number of times the user has made purchases with the merchant 50a in a predefined past period, e.g. in the past 3 months.

A second parameter P2 relates to user feedback data or score of a merchant 50a. The feedback data may be based on a feedback score provided by the user and/or feedback scores provided by other users. Different weights may be applied to the feedback scores provided by the user and other users. For example, there may be a greater weighting for the feedback score provided by the user that is making the current purchase.

A third parameter P3 relates to past history of delivery time taken by a merchant 50a. The time of delivery is calculated as difference between the date that an order/purchase was placed and date that the order/purchase was delivered. It can be calculated based on data provided by merchant 50a or based on data obtained from the user. For example, user can scan an invoice, purchase order, or delivery receipt that indicates the date of order/purchase and date of delivery. Similarly, the merchant 50a may provide the delivery data to the server 100, e.g. by having delivery records on the merchant database 40. The delivery dates may also be tracked by making use of the payment network 300, such as only releasing funds to the merchant 50a after the merchant 50a has confirmed successful delivery to the user. In some embodiments, the third parameter P3 may be integrated with the first parameter P1 relating to the frequency and recency of prior purchase with the merchant 50a.

A fourth parameter P4 relates to affinity of the user for certain merchants 50 for certain type of products 30 based on prior history or user experience. For example, the user may input priority indications for some merchants 50a which the user prefers to purchase products 30 from. Further in this example, the user may indicate specific products 30a to be purchased only from specific merchants 50a or the user may indicate specific categories of products 30a, e.g. cosmetics, to be purchased from specific merchants 50a. In this example, all cosmetics products 30a may get same affinity score for that merchant 50a. Affinity-based sub-scores for each merchant 50a are calculated for this fourth parameter P4.

A fifth parameter P5 leverages on transaction data and other third party data sources to define the performance of a merchant 50a. The transaction data includes historical transaction data of the user and the merchants 50a, e.g. for transactions occurring between the user and the merchants 50a. The performance of a merchant 50a may be defined based on factors such as transaction spend, transaction volume, available offers/discounts, etc. If the user purchases some products 30a in bulk, the bulk purchase may be eligible for discounts and some merchants 50a may offer such discounts. This may improve their sub-score for this fifth parameter P5.

The step 408 thus calculates an overall score for each merchant 50a based on all the sub-scores from the parameters P. In some embodiments, the calculated sub-scores for each parameter P and the assigned weights W are exposed to the user, such that the user has the option to adjust the parameters P and weights W according to his/her preference. The parameters P may include a sixth parameter P6 relating to the weights W of all parameters P. Specifically, the parameter P6 considers whether the user has defined weights W for the various parameters P.

In the step 410, after calculating the scores for all the merchants 50a, a number of the merchants 50a are ranked according to their scores. In some embodiments, other factors, e.g. price-related factors, may be taken into consideration during calculation of the scores and/or ranking of the merchants 50a. At least one of the ranked merchants 50a is then selectable, e.g. by the user or automatically by the server 100, for purchasing the selected products 30a at the respective prices collected in the step 406. The step 410 may rank all the merchants 50a or only some of the merchants 50a, e.g. the top 10. Ranking a smaller number of the merchants 50a may provide the user with greater convenience in deciding which merchant(s) to select for purchasing the selected products 30a.

In some embodiments, the selected products 30a are allocated into different groups, such as based on priority or importance of a group of products to the user. In one embodiment, the method 400 further includes receiving, from the electronic device 200, a priority indication provided by the user for each selected product 30a, wherein the selected products 30a are allocated into successive groups of products according to the priority indications. The user may include the priority indication when he/she makes the selection of the products 30a. For example, the user may indicate whether a particular product 30a (that he/she wishes to purchase) is of high (e.g. must have items), medium (e.g. items that do not fall into high or low priority), or low priority (e.g. items that are not a must to purchase). Alternatively, the server 100 may obtain the priority indications for the selected products 30a based on prior history of the user. For example, the user may have purchased some products 30a more frequently than others—such products 30a may be indicated as high priority. The selected products 30a are then allocated into the relevant groups—high-priority products, medium-priority products, and low-priority products—based on the priority indications.

If there are priority indications for the selected products 30a, the set of parameters P further includes a seventh parameter P7 relating to whether a merchant 50a has in its inventory at least a predefined percentage (e.g. 75%) of the high priority products 30a. The predefined percentage may be defined by the user, defined by the server 100, or statistically calculated based on inventory data and transaction data. In some embodiments, merchants 50a with inventory below the predefined percentage for high priority products 30a are excluded from further processing in the pricing algorithm.

In various embodiments, the application provides the user with various options and filters for the user to define parameters to customize his/her user profile and/or purchase order/instructions. Some parameters include, but are not limited to geospatial preferences (e.g. merchant locations), delivery options, availability of bulk purchase discounts, whether the merchants 50 are contactable, viewing of merchant locations on online maps, indicating a preferred price range for one or more of the selected products 30a, and acceptance of cashless payment modes such as credit cards. To enhance the online shopping experience, some users may prefer merchants (and may customize his/her profile as such) to have presence of a merchant visual shopping (MVS) facility, virtual reality based augmented shopping facility, and/or offline mode facility (i.e. brick-and-mortar store). In some embodiments, the application provides the user with an option to configure recurring orders, such as for products 30a that are periodically replaced (e.g. disposable contact lens). The configuration of recurring orders may allow the user to predefine the prices for the recurring products 30a, e.g. at the present lowest price, so as to avoid being affected by potential price increases in future.

In some embodiments, the user selects from the ranked merchants 50a to purchase the selected products 30a. The server 100 communicates a list of the ranked merchants 50a to the electronic device 200, and presented thereon by the application, for the user to select the one or more merchants 50a for purchasing the selected products 30a. More particularly, there is a list of ranked merchants 50a for each selected product 30a and each list may be presented in two different formats.

The first format displays the ranked merchants 50a as recommended by the server 100, specifically by the pricing algorithm, offering the best deals for the selected products 30a in the top two or three rows. The list may be presented in the first format if there is no user input or any specific user-defined options. Instead, the list in the first format considers available merchant data and transaction data to rank the merchants 50a. The second format displays the ranked merchants 50a after consideration of all the user-defined options. Particularly, the second format shows the ranked merchants 50a in descending order, with the highest-ranked merchant 50a in the top row. Based on the displayed list or lists, the user can select the appropriate merchant(s) 50a according to his/her preferences and make the purchase. In the step 412, the server 100 receives, from the electronic device 200, the user selection of one or more merchants from the ranked merchants 50a.

In the subsequent step 414, the server 100 communicates or transmits purchase instructions for the selected products 30a from the selected merchants 50a at the respective prices. In other words, the server 100 places an order by transmitting the purchase instructions to the selected merchants 50a for purchase of the selected products 30a therefrom, and specifically at the respective prices collected from the selected merchants 50a in the step 406. In one embodiment, the purchase instructions require the user to make payment directly to the selected merchants 50a at the respective collected prices. In another embodiment, the server 100 or a payment account linked thereto pays on behalf of the user to the selected merchants 50a, and the user subsequently returns the purchase amount to the payment account. In one example, the amount paid by the payment account to the selected merchants 50a (“first amount”) may be the same as the amount paid by the user to the payment account (“second amount”), i.e. equal to the sum of the collected prices of the selected products 30a. There is thus zero spread or difference between the first amount and second amount. In another example, the amount paid by the payment account to the selected merchants 50a may be lower than the amount paid by the user to the payment account. There is thus a non-zero spread or difference between the first amount and second amount. The non-zero spread may be for incentivizing the server 100 to collect and aggregate prices from various merchants 50 to benefit the user.

According to the second aspect of the present disclosure and with reference to FIG. 2B, there is shown a computer-implemented or computerized method 450, i.e. implemented on a computer or computer system such as or including the server 100, for facilitating product purchase. In some embodiments of the present disclosure, the method 450 broadly includes a step 452 of receiving, such as by the communications module or component 100a of the server 100 and from an electronic device 200 of a user, a user selection of products 30a for purchase thereof, a step 454 of identifying, such as by the identification module or component 100b of the server 100 and from a merchant database 40, a plurality of merchants 50 to provide the selected products 30a, a step 456 of collecting prices, such as by the price collection module or component 100c of the server 100, for the selected products 30a from the merchants 50, a step 458 of calculating, such as by the score calculation module or component 100d of the server 100, a score for each merchant 50 based on a set of parameters, a step 460 of automatically performing a merchant selection process 500, such as by a merchant selection module or component of the server 100, for selecting one or more merchants 50a based on at least one of their prices and scores, and a step 462 of transmitting, such as by the purchasing module or component 100f, purchase instructions for the selected products 30a from the selected merchants 50a at the respective prices.

Instead of having the user to browse through a list of the ranked merchants 50 and select the merchants 50a, the server 100 thus automatically selects the merchants 50a for purchasing the selected products 30a. Accordingly, after the user selects the products 30a to purchase, the server 100 automatically performs the merchant selection process 500 to select the merchants 50a with the best deals for the user based on predefined algorithms or rules. The entire purchase process can thus be largely automated and paid for if the user has predefined his/her payment instrument details prior to or during selection of the products 30a. For purpose of brevity, it will be appreciated that various aspects of the method 400 may be applied similarly or analogously to the method 450.

The method 450 includes the step 460 of automatically performing the merchant selection process 500 for selecting, e.g. by the merchant selection module or component of the server 100, the one or more merchants 50a. Specifically, the one or more merchants for purchasing the selected products 30a are selected based on at least one of (i) calculated scores of the merchants 50 (from the step 458), and (ii) collected prices from the merchants 50 (from the step 456) for the selected products 30a.

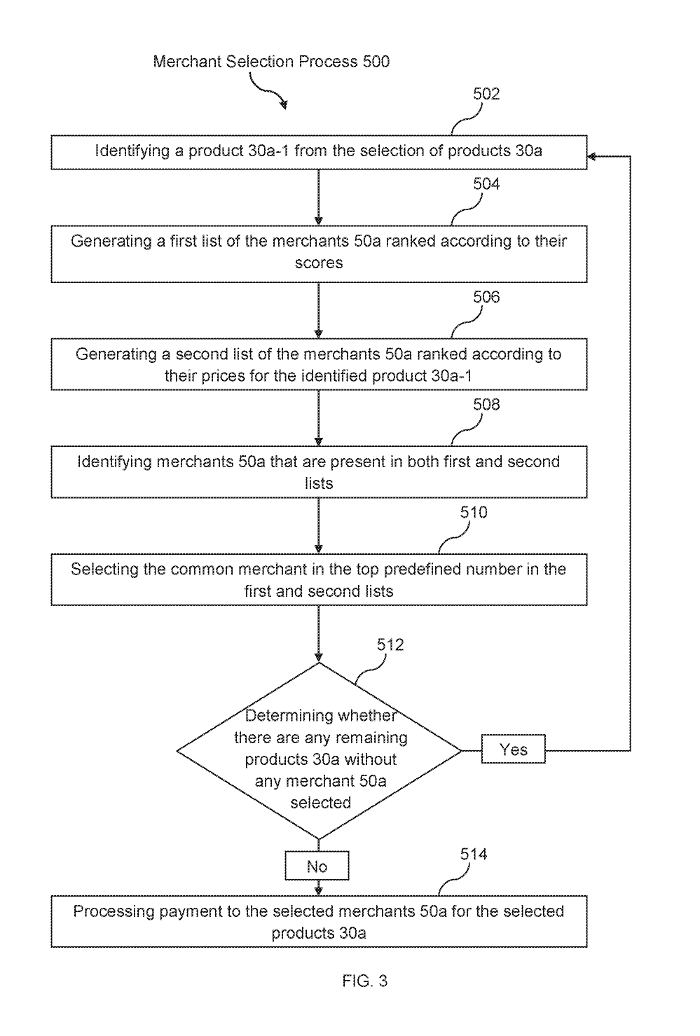

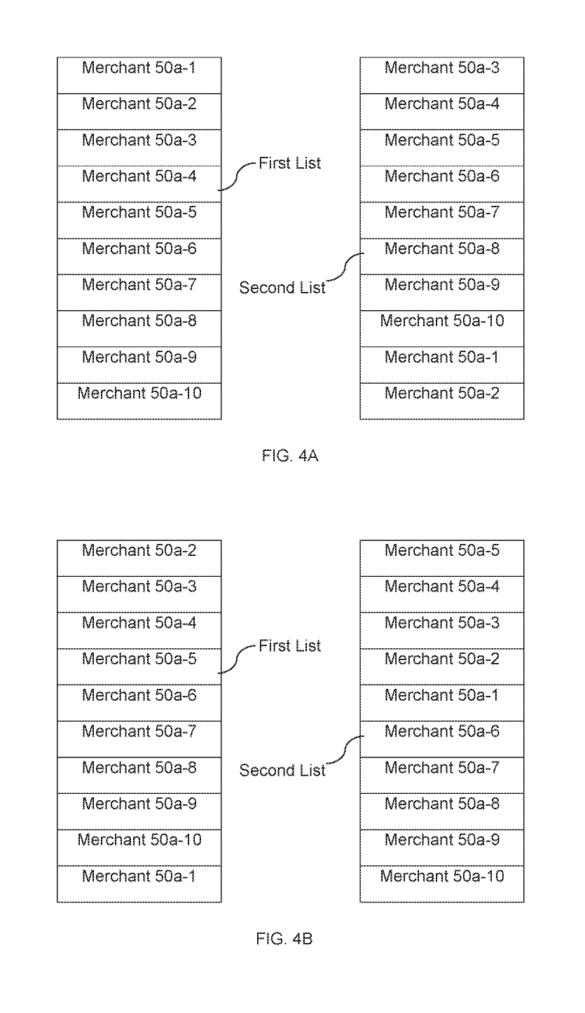

With reference to FIG. 3, the merchant selection process 500 includes a step 502 of identifying a product 30a-1 from the selected products 30a. The merchant selection process 500 further includes a step 504 of generating a first list of the merchants 50a ranked according to their scores calculated in the step 458. The merchant 50a with the highest score is ranked top. The merchant selection process 500 further includes a step 506 of generating a second list of the merchants 50a ranked according to their prices (collected in the step 456) for the identified product 30a-1. The merchant 50a with the lowest price for the identified product 30a-1 is ranked top. FIG. 4A illustrates an example of the first and second lists with 10 merchants 50a-1 to 50a-10. In some embodiments, other factors, e.g. price-related factors, may be taken into consideration during generation of the second list.

The merchant selection process 500 further includes a step 508 of identifying merchants 50a that are present in both first and second lists. Specifically, the step 508 identifies the top predefined number of merchants 50a in the first list and the same top predefined number of merchants 50a in the second list. In some embodiments, this predefined number is 3, i.e. the top 3 merchants 50a in both lists. The step 508 identifies whether there is any common merchant 50a present in the top 3 of both lists. If there is no common merchant 50a, the predefined number may be changed to compare a larger number of merchants 50a in both lists. Referring to the example shown in FIG. 4A, merchant 50a-3 is the sole merchant that is present in the top 3 of the first and second lists.

The merchant selection process 500 further includes a step 510 of selecting the common merchant in the top predefined number in the first and second lists. Following from the previous example, the common merchant 50a-3 is selected and the identified product 30a-1 is purchased from the common merchant 50a-3 in the step 462.

The merchant selection process 500 further includes a step 512 of determining whether there are any remaining products 30a without any merchant 50a selected. If yes, the step 512 proceeds to repeat the steps 502, 504, 506, 508, and 510 for the subsequent products 30a-2, 30a-3, etc. If no, i.e. all the selected products 30a have the respective merchants 50a selected, the step 512 proceeds to a step 514 of processing payment to the selected merchants 50a for the selected products 30a.

In some embodiments, the step 508 identifies more than one common merchant 50a present in the top predefined number in the first and second lists. FIG. 4B illustrates another example of the first and second lists with 2 common merchants 50a-3 and 50a-4 present in the top 3 of both lists. If one of the common merchants 50a-3 and 50a-4 is also ranked top in the second list, i.e. has the lowest price, then this common merchant is selected in the step 512. If none of the common merchants 50a-3 and 50a-4 is ranked top in the second list, then the one with the smallest price difference with the top-ranked (lowest price) merchant 50a-5 in the second list (as shown in FIG. 4B) is selected as the common merchant in the step 512. The difference in price may be calculated arithmetically, i.e. by simple subtraction, or by some other mathematical functions.

As described above, each selected product 30a initiates an iteration of the steps 502, 504, 506, 508, and 510. The merchant selection process 500 thus selects common merchants 50a iteratively for each selected product 30a. In some embodiments, the selected products 30a are allocated into different groups, such as based on priority or importance of a group of products to the user. In one embodiment, the method 450 further includes receiving, from the electronic device 200, a priority indication provided by the user for each selected product 30a, wherein the selected products 30a are allocated into successive groups of products according to the priority indications.

In one embodiment, the common merchants 50a are selectable according to the successive groups of products (grouped by the priority indications). For example, common merchants 50a are firstly selected for the high-priority products and lastly for the low-priority products. Further, if there is no one common merchant 50a that is able to provide all the products in one group, additional merchants 50a are subsequently selected by the merchant selection process 500. In one example, if the first selected merchant 50a can only provide the products for one group, e.g. only the high-priority products, subsequent merchant(s) 50a are successively selected until the remaining groups of products can be provided. In another example, if the first selected merchant 50a can only provide a subset of the products in one group, e.g. only some of the high-priority products, subsequent merchant(s) 50a are successively selected until the remaining products in the group can be provided. The merchant selection process 500 thus selects common merchants 50a iteratively for each selected product 30a in a group of products before the succeeding group of products. Failure for one selected merchant 50a to provide all selected products 30a in a group can be due to various reasons, such as the user not ordering the minimum quantity of products 30a that the merchant 50a requires, and/or the merchant 50a has low inventory/stock for some of the selected products 30a.

Therefore, by selecting the merchants 50a through the merchant selection process 500, merchants 50a that are ranked highly on the first list, i.e. with a high score calculated in the step 458, also offer one of the lowest prices for the selected products 30a. The user can advantageously get a better deal for his/her purchase of the selected products 30a at the best possible value.

In some embodiments of the method 400/450, users and merchants 50 are provided with options to configure various parameters in the set of parameters. For example, among the ranked merchants 50a, a user may prefer some of the ranked merchants 50a over the others. The user can indicate a preference indication for these merchants 50a or it can be determined based on historical transaction data, e.g. by the frequency of past purchases with these merchants 50a. The preference indication includes a price premium that the user is willing to pay above a benchmark price, e.g. the lowest price for a selected product 30a. The price premium may be a fixed quantum or percentage premium above the benchmark price. For example, the user may be loyal to and prefer to purchase from merchants 50a-3 and 50a-4, such that the user is willing to pay a price premium. The price premium may be 5% above the lowest price for merchant 50a-3 and 3% above the lowest price for merchant 50a-4. It will be appreciated that the price premium is defined by the user based on his/her loyalty to merchants. To take into consideration the price premiums, the prices offered by the merchants 50 are adjusted accordingly to reflect the price premiums.

Each merchant 50 may similarly predefine a discount for certain users based on their loyalty to them. For example, historical transaction data may inform the merchants 50 that certain users frequently purchase from them. Such merchants 50 may predefine a discount, e.g. 5% off their offered price, for these users. To take into consideration the predefined discounts, the prices offered by the merchants 50 are adjusted accordingly to reflect the predefined discounts. In the merchant selection process 500, the second list of merchants 50a from the step 506 may be revised accordingly in consideration of the price premiums or discounts.

In various embodiments, the selected products 30a are allocated into multiple groups based on factors other than priority indications. In one embodiment, the selected products 30a are grouped based on transaction data of past purchases between the user and the identified merchants 50a. For example, if the user tended to purchase some of the selected products 30a with one merchant 50a, these would be allocated into one group of products. In another embodiment, the selected products 30a are grouped based on current inventory data of the identified merchants 50a. For example, if one merchant 50a can provide some of the selected products 30a, these would be allocated into one group of products to reduce the total number of merchants 50a providing the selected products 30a.

In some embodiments, the merchants 50a are allocated into multiple groups based on various factors such that the groups of merchants 50a can provide or supply all the selected products 30a more effectively. In addition, the grouping of the selected products 30a may be such that the total number of merchants 50a supplying the selected products 30a is minimized for greater efficiency. Alternatively, the grouping of the selected products 30a may be such that total number of merchants 50a is maximized, e.g. one merchant 50a supplying one type of the selected products 30a, so as to diversify the supply sources and allow more merchants 50a to capture a portion of this purchase transaction.

In one embodiment, the grouping of merchants 50a considers various factors such as whether a merchant 50a is willing to offer a discount if grouped with another merchant 50a. This group of merchants 50a may also take into account the profit and loss maintenance and geospatial attributes of the group, such as whether they are located close enough to operate together efficiently and whether there is any profitability or commercial advantage to group together. Merchants 50a may also be grouped together in a manner that offers the lowest price for the user, i.e. one that is most cost effective to the user, in view of the multiple possible combinations and permutations of the groups of merchants 50a.

As the products 30a/merchants 50a can be allocated into groups, the merchants 50a may offer prices for the selected products 30a at the individual product/merchant level (each merchant 50a offering a price for one selected product 30a) or at the group product/merchant level (each merchant 50a offering a price for a group of the selected products 30a or each group of merchants 50a offering a price for a group of the selected products 30a, such that the collected prices are associated with the groups). Further, if a merchant 50a is able to supply all of the selected products 30a, the merchant 50a may offer an overall price instead.

In some embodiments, where the user has defined a preferred price range for one or more of the selected products 30a, the prices offered by the merchants 50a are checked against the preferred price range. In one embodiment, if an offer price from a merchant 50a is close to the upper end of the price range, the merchant 50a will be invited to offer a discount to adjust the offer price closer to the middle of the price range. In another embodiment, the merchant 50a may have predefined a discount, such as in view of the user's loyalty to the merchant 50a, and this discount is automatically applied to adjust the offer price closer to the middle of the price range. In yet another embodiment, the merchant 50a may communicate directly with the user and offer special promotional discounts or offers to the user.

In various embodiments, the user is able to configure on the application whether to manually select the merchants 50a for purchasing the selected products 30a (i.e. performing the method 400) or to have the server 100 automatically select the merchants 50a via the merchant selection process 500 (i.e. performing the method 450).

In one embodiment, that the user can configure whether to enable the server 100 to allocate the selected products 30a and/or identified merchants 50a into groups. For example, the user may choose to disable grouping of products/merchants and have the server 100 perform the method 400 of ranking the merchants 50a for the user to then decide which one or more merchants to purchase the selected products 30a from. The user may also choose to enable grouping of products/merchants and have the server 100 perform the method 450 of automatically selecting the merchants 50a for the user.

As described above, the user initiates the method 400/450 for facilitating product purchase with the electronic device 200. However, it may happen that there is no internet connectivity at the time of initiation, preventing communication between the electronic device 200 and the server 100. In one embodiment, the user can still proceed to select from the products 30 for purchase. This selection of products 30a is stored on the electronic device 200 and is later communicated to the server 100 once there is internet connectivity. In another embodiment, the user saves a list of emergency products 30b, e.g. medicine, with the application. The application provides an emergency input interface that the user can activate and automatically initiate the method 400/450 for facilitating purchase of the emergency products 30b.

In some embodiments, the server 100 is configured with a machine learning system to improve the method 400/450, particularly the pricing algorithm. For example, the machine learning system collects relevant data from all purchases made by users with the merchants 50 to better understand consumer and merchant needs and fine-tune the pricing algorithm.

In some embodiments, instead of executing the application on the electronic device 200, the user may execute the method 400/450 with a simple user interface such as a texting or messaging platform. For example, the user may send an SMS to a predefined number (or short code) operated by the server 100. The SMS may be in the form of “#ProductName Quantity”, e.g. “#WashingPowder 500g”. Some social media platforms such as Facebook® support messaging services and the user may be able to initiate the method 400/450 for purchase of products 30 via such platforms. For example, If the user intends to purchase an iPhone® from specific merchants 50, e.g. WalMart® or Amazon®, the user can input the data in the form “#iPhone#WalMart#Amazon”. Further to this example, if the user prefers WalMart® or Amazon® over other merchants 50, the user may indicate a price premium that he/she is willing to pay above a benchmark price of the iPhone. The user may input the data in the form “#iPhone#WalMart#2%#Amazon#3%”, wherein the percentage values represent the price premium. In one embodiment, instead of a generic input interface wherein the user can input a string of characters, the texting or messaging platform may provide an exhaustive user interface with specific fields for the user to provide data inputs.

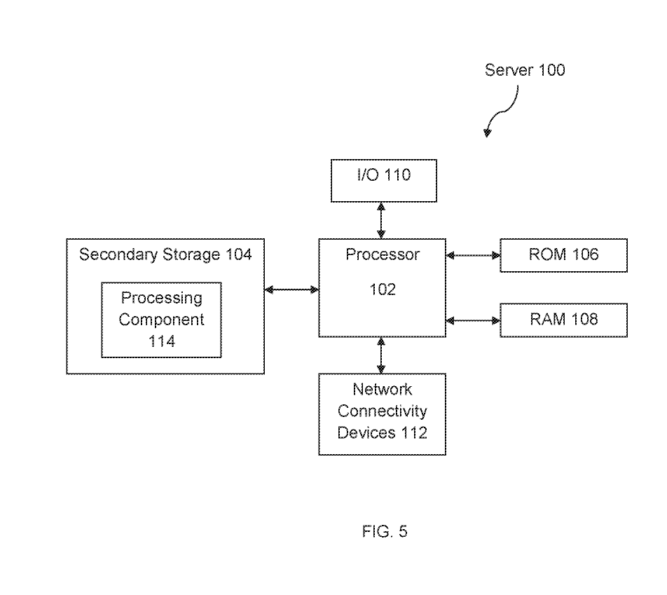

As mentioned above with reference to FIG. 1B, the server 100 includes the communications module 100a for receiving a user selection of products 30 for purchase thereof and selection of merchants 50, an identification module 100b for identifying a plurality of merchants 50 to provide the selected products 30a, a price collection module 100c for collecting prices for the selected products 30a from the merchants 50, a score calculation module 100d for calculating a score for each merchant 50 based on a set of parameters, a ranking module 100e for ranking a number of the merchants 50 according to their scores, and a purchasing module 100f for transmitting purchase instructions for the selected products 30a from the selected merchants 50a. In addition, FIG. 5 illustrates a block diagram showing a technical architecture of the server 100.

The technical architecture of the server 100 includes a processor 102 (also referred to as a central processor unit or CPU) that is in communication with memory devices including secondary storage 104 (such as disk drives or memory cards), read only memory (ROM) 106, and random access memory (RAM) 108. The processor 102 may be implemented as one or more CPU chips. The various modules 100a-f are configured as part of the processor 102 for performing various operations or steps of the method 400/450 in response to non-transitory instructions operative or executed by the processor 102.

The technical architecture further includes input/output (I/O) devices 110, and network connectivity devices 112. The secondary storage 104 typically includes a memory card or other storage device and is used for non-volatile storage of data and as an over-flow data storage device if RAM 108 is not large enough to hold all working data. Secondary storage 104 may be used to store programs which are loaded into RAM 108 when such programs are selected for execution.

The secondary storage 104 has a processing component 114, including non-transitory instructions operative by the processor 102 to perform various operations of the method 400/450 according to various embodiments of the present disclosure. The ROM 106 is used to store instructions and perhaps data which are read during program execution. The secondary storage 104, the ROM 106, and/or the RAM 108 may be referred to in some contexts as computer-readable storage media and/or non-transitory computer-readable media. Non-transitory computer-readable media include all computer-readable media, with the sole exception being a transitory propagating signal per se.

The I/O devices 110 may include printers, video monitors, liquid crystal displays (LCDs), plasma displays, touch screen displays, keyboards, keypads, switches, dials, mice, track balls, voice recognizers, card readers, paper tape readers, and/or other known input devices.

The network connectivity devices 112 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other known network devices. These network connectivity devices 112 may enable the processor 102 to communicate with the Internet or one or more intranets. With such a network connection, it is contemplated that the processor 102 might receive information from the network, or might output information to the network in the course of performing the operations or steps of the method 400/450. Such information, which is often represented as a sequence of instructions to be executed using processor 102, may be received from and outputted to the network, for example, in the form of a computer data signal embodied in a carrier wave.

The processor 102 executes instructions, codes, computer programs, scripts which it accesses from hard disk, floppy disk, optical disk (these various disk based systems may all be considered secondary storage 104), flash drive, ROM 106, RAM 108, or the network connectivity devices 112. While only one processor 102 is shown, multiple processors may be present. Thus, while instructions may be discussed as executed by a processor, the instructions may be executed simultaneously, serially, or otherwise executed by one or multiple processors.

It should be appreciated that the technical architecture of the server 100 may be formed by one computer, or multiple computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the multiple computers. In an embodiment, virtualization software may be employed by the technical architecture to provide the functionality of a number of servers that is not directly bound to the number of computers in the technical architecture. In an embodiment, the functionality disclosed above may be provided by executing the application and/or applications in a cloud computing environment. Cloud computing may include providing computing services via a network connection using dynamically scalable computing resources. A cloud computing environment may be established by an enterprise and/or may be hired on an as-needed basis from a third party provider.

It is understood that by programming and/or loading executable instructions onto the technical architecture of the server 100, at least one of the CPU 102, the ROM 106, and the RAM 108 are changed, transforming the technical architecture in part into a specific purpose machine or apparatus having the functionality as taught by various embodiments of the present disclosure. It is fundamental to the electrical engineering and software engineering arts that functionality that can be implemented by loading executable software into a computer can be converted to a hardware implementation by known design rules.

In the foregoing detailed description, embodiments of the present disclosure in relation to an electronic system and method for facilitating product purchase are described with reference to the provided figures. The description of the various embodiments herein is not intended to call out or be limited only to specific or particular representations of the present disclosure, but merely to illustrate non-limiting examples of the present disclosure. The present disclosure serves to address at least one of the mentioned problems and issues associated with the prior art. Although only some embodiments of the present disclosure are disclosed herein, it will be apparent to a person having ordinary skill in the art in view of this disclosure that a variety of changes and/or modifications can be made to the disclosed embodiments without departing from the scope of the present disclosure. Therefore, the scope of the disclosure as well as the scope of the following claims is not limited to embodiments described herein.

1. An electronic system for facilitating product purchase, the system comprising a server including a processor and a memory configured to store computer-readable instructions, wherein when the instructions are executed, the processor performs steps comprising:
receiving, from an electronic device of a user, a user selection of products for purchase thereof;
identifying, from a merchant database, a plurality of merchants to provide the selected products;
collecting prices for the selected products from the merchants;
calculating a score for each merchant based on a set of parameters;
ranking a number of the merchants according to their scores;
receiving, from the electronic device, a user selection of one or more merchants from the ranked merchants; and
transmitting purchase instructions for the selected products from the selected merchants at the respective prices.

2. The electronic system according to claim 1, the steps further comprising requesting the merchants to offer their prices for the selected products.

3. The electronic system according to claim 1, the steps further comprising communicating a list of the ranked merchants to the electronic device for the user to select the one or more merchants.

4. The electronic system according to claim 1, the steps further comprising allocating the selected products into groups.

5. The electronic system according to claim 4, the steps further comprising receiving, from the electronic device, a priority indication for each selected product, wherein the selected products are allocated into successive groups of products according to the priority indications.

6. The electronic system according to claim 5, wherein the selected merchants are selected by the user according to the successive groups of products.

7. The electronic system according to claim 4, wherein the collected prices are associated with the groups of products.

8. The electronic system according to claim 1, wherein the set of parameters comprises at least one of historical transaction data of the user and merchants, user feedback data of the merchants, and user-defined parameters.

9. (canceled)

10. (canceled)

11. The electronic system according to claim 8, wherein the user-defined parameters comprise at least one of a preferred price range for one or more of the selected products and a price premium for the merchants.

12. (canceled)

13. (canceled)

14. A computerized method implemented on a server for facilitating product purchase, the method comprising:
receiving, from an electronic device of a user, a user selection of products for purchase thereof;
identifying, from a merchant database, a plurality of merchants to provide the selected products;
collecting prices for the selected products from the merchants;
calculating a score for each merchant based on a set of parameters;
ranking a number of the merchants according to their scores;
communicating a list of the ranked merchants to the electronic device for the user to select one or more merchants;
receiving, from the electronic device, a user selection of the one or more merchants from the ranked merchants; and
transmitting purchase instructions for the selected products from the selected merchants at the respective prices.

15. The method according to claim 14, further comprising requesting the merchants to offer their prices for the selected products.

16-20. (canceled)

21. The method according to claim 14, wherein the set of parameters comprises at least one of historical transaction data of the user and merchants, user feedback data of the merchants, and user-defined parameters.

22-27. (canceled)

28. An electronic system for facilitating product purchase, the system comprising a server including a processor and a memory configured to store computer-readable instructions, wherein when the instructions are executed, the processor performs steps comprising:
receiving, from an electronic device of a user, a user selection of products for purchase thereof;
identifying, from a merchant database, a plurality of merchants to provide the selected products;
collecting prices for the product from the merchants;
calculating a score for each merchant based on a set of parameters;
automatically performing a merchant selection process for selecting one or more merchants based on at least one of their prices and scores; and
transmitting purchase instructions for the selected products from the selected merchants at the respective prices.

29. The electronic system according to claim 28, wherein the merchant selection process comprises:
identifying a product from the selected products;
generating a first list of the merchants ranked according to their scores,
generating a second list of the merchants ranked according to their prices; and
selecting a common merchant present in a top predefined number of the merchants in the first and second lists.

30. The electronic system according to claim 29, wherein the merchant selection process selects the common merchants iteratively for each selected product.

31. The electronic system according to claim 30, the steps further comprising allocating the selected products into groups.

32. The electronic system according to claim 31, the steps further comprising receiving, from the electronic device, a priority indication for each selected product, wherein the selected products are allocated into successive groups of products according to the priority indications.

33. The electronic system according to claim 32, wherein the merchant selection process selects the common merchants iteratively for each selected product in a group of products before the succeeding group of products.

34. The electronic system according to claim 28, wherein the set of parameters comprises at least one of historical transaction data of the user and merchants, user feedback data of the merchants, and user-defined parameters.

35. (canceled)

36. (canceled)

37. The electronic system according to claim 34, wherein the user-defined parameters comprise at least one of a preferred price range for one or more of the selected products and a price premium for the merchants.

38-52. (canceled)
